(19) United States
(12) Patent Application Publication
(10) Pub. No.: US 2007/0241205 A1
(43) Pub. Date: Oct. 18, 2007

(54) Fountain That Flows With Multiple Fluidic Materials

(76) Inventors: Daniel P. Fuglewicz, Depew, NY (US); Chris J. Nowak, Cheektowaga, NY (US); Glenn D. Wilson, Williamsville, NY (US)

Correspondence Address: JAECKLE FLEISCHMANN & MUGEL, LLP, 190 Linden Oaks, ROCHESTER, NY, 14625-2812, US

(21) Appl. No.: 11/279,968

(22) Filed: Apr. 17, 2006

(51) Int. Cl. B05B 17/08

(52) U.S. Cl. 239/23; 239/20

(57) ABSTRACT

A fountain flows with multiple fluidic materials. The fountain has a basin, multiple augers, a tubular housing for the augers and tiers, all configured so that the multiple fluidic materials flow through the fountain without mixing. The basin and tiers preferably have dividers to prevent the multiple fluidic materials from mixing. The fountain is suitable for home as well as commercial use.

### BACKGROUND

Fondue machines typically include a bowl shaped container for holding and heating foods such as chocolate, cheese and the like. The container is heated by a heating element to melt the food. Fruit, bread, or other food items, may then be dipped into the container of the fondue machine.

In recent years, fondue machines have taken on alternate configurations. For example, Design & Realisation Inc. in Montreal, Canada markets a chocolate fountain that moves melted chocolate so that it flows over a number of tiers like a fountain. Note that material other than chocolate may be used in these devices. FIG. 1 is a diagram illustrating a prior art chocolate fountain 100, such as the fountain marketed by Design & Realisation Inc. As shown in FIG. 1, the chocolate fountain 100 includes a container 110 configured to hold and melt chocolate. A hollow barrel 120 is mounted in the center of the container 110 and provides a pathway for melted chocolate to be moved upward, through its hollow center, to the top of the fountain. An auger including a spiral flight extending around the length of the auger is mounted within the hollow barrel 120. The auger is rotated in order to lift the melted chocolate upward in the hollow barrel 120. On the top of the barrel 120 is a crown 140 that fills with chocolate that flows out of the barrel 120. When the crown 140 is full of melted chocolate, the chocolate begins to fall over the edges of the crown 140. Attached to the barrel 120 are tiers 130, which vary in size. As the chocolate flows downwardly from the crown 140, the chocolate flows over each of the tiers 130, thus forming a multi-level chocolate waterfall. The chocolate fountain 100 also includes a heating element that is placed below the container 110.

It may be desirable to have several types of fondues at an event. For example, it may be desirable to have fondues of several types of chocolates, cheeses, and/or sauces.

There is a need in the art for a fondue fountain that flows with multiple fluidic materials.

### SUMMARY

A fountain comprises a basin configured to contain fluidic material; a housing substantially perpendicular to the basin and configured to contain the fluidic material; and a plurality of augers configured to move the fluidic material within the basin upwardly within the housing, wherein substantially all of the fluidic material returns to the basin via a path outside of the housing, after the augers move the fluidic material to a top of the housing.

The basin and the housing are configured to contain multiple fluidic materials so that there is substantially no mixing of the multiple fluidic materials in the basin. The basin preferably has dividers substantially impermeable to fluid. Alternatively, the fountain has a plurality of basins.

Each auger is configured to move a single fluidic material within the basin upwardly within the housing.

The fountain has tiers configured so that the multiple fluidic materials flow over the tiers when flowing from the housing to the basin and so that the multiple fluidic materials substantially do not mix when flowing over the tiers. The tiers have dividers substantially impermeable to fluid.

In another embodiment, a fountain comprises a basin configured to contain fluidic material; a plurality of housings substantially perpendicular to the basin and configured to contain the fluidic material; and a plurality of augers configured to move the fluidic material within the basin upwardly within the plurality of housings, wherein substantially all of the fluidic material returns to the basin, via a path outside of the plurality of housings, after the augers move the fluidic material to a top of the plurality of housings.

In a further embodiment, a fountain comprises at least one basin configured to contain multiple fluidic materials so that there is substantially no mixing of the multiple fluidic materials in the at lease one basin; at least one housing substantially perpendicular to the at least one basin and configured to contain the multiple fluidic materials; and a moving means configured to move the multiple fluidic materials within the at least one basin upwardly within the at least one housing, wherein substantially all of the multiple fluidic materials return to the at least one basin via a path outside of the at least one housing after the moving means moves the multiple fluidic materials to a top of the at least one housing. The at least one housing is configured so that there is substantially no mixing of the multiple fluidic materials in the at least one housing.

### BRIEF DESCRIPTION OF THE DRAWINGS

These and other features, aspects, and advantages of the present invention will become better understood with regard to the following description, appended claims, and accompanying drawings where:

FIG. 1 is a side elevation view of a prior art chocolate fountain;

FIG. 2 is a side elevation view of a fountain embodying the invention;

FIG. 3 is a top view of the fountain of FIG. 2; and

FIG. 4 is a cross-sectional side view of the fountain of FIG. 3 taken at line A-A.

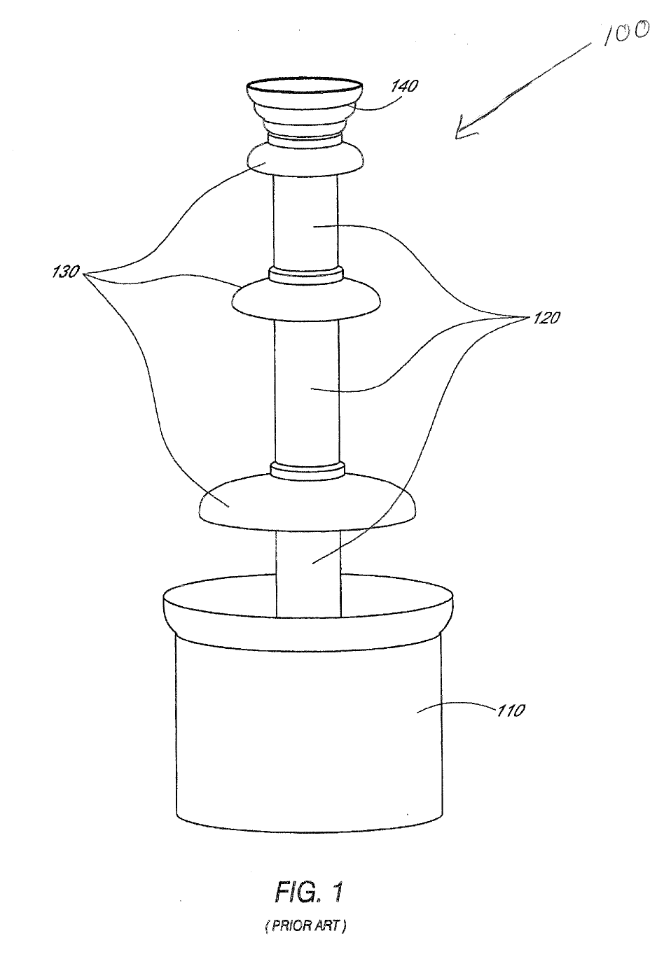

### DETAILED DESCRIPTION OF PREFERRED EMBODIMENTS

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

A fountain configured for containing multiple fluidic materials comprises a basin and multiple augers. The augers transport the multiple fluids from the basin before the fluids return to the basin. Preferably, the fluidic materials do not mix in the fountain. The fountain is suitable for home as well as commercial use. The fountain is useful for elegantly serving and presenting multiple types of fondues simultaneously. For example, the fountain can flow with multiple types of melted chocolate, cheeses, or sauces simultaneously. Or, as only one example, can be used to serve chocolate, cheese and barbeque sauces simultaneously.

In one embodiment, the fountain flows with melted chocolate and is therefore referred to as a chocolate fountain. However, while reference is made herein to the use of chocolate in the fountain, the systems and methods described herein are not limited to the use of chocolate. In particular, any other fluidic material which a user wishes to circulate through the fountain may be used instead of chocolate. For example, other confectionery items, such as caramel, toffee, taffy, or marshmallows; dairy products, such as cheese; or flavorings, such as mint or fruit, may be used in the fountain. Additionally, different varieties of chocolate, such as white chocolate, dark chocolate, or milk chocolate, may be used in the fountain. Furthermore, any combination of food items, such as a combination of chocolate and caramel, for example, may be used in the fountain. Yet further, the fluidic material(s) may comprise a beverage or beverages.

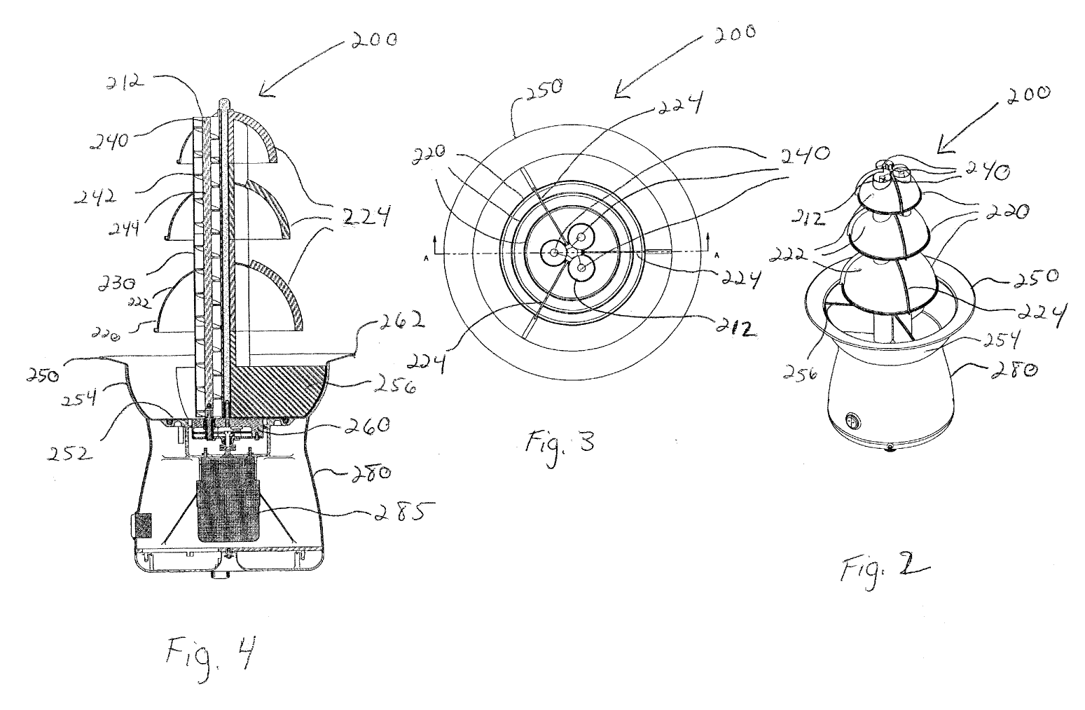

As shown the embodiment in FIGS. 2-4, the fountain 200 comprises a base 280, upon which a basin 250 is mounted. Three augers 240 each having a spiral flight 242 surrounding a central shaft 244 are coupled to the bottom surface 252 of the basin 250. The base 280 houses a drive motor 285 and heating element 260. The drive motor 285 engages each auger 240 and applies a rotational force causing the augers to rotate and thereby lift, for example, melted chocolate upward inside a tubular housing 230 attached to the basin 250, the chocolate traveling upwardly upon the top surface of the spiral flight 242. Then the melted chocolate flows over a top 212 of the tubular housing 230.

As shown in the embodiment of FIGS. 2-4, the chocolate fountain 200 includes three tiers 220 that are each attached to the housing 230. In other embodiments, any number of tiers 220, such as 1, 2, 4, 5, or 6, for example, may be attached to the tubular housing 230. A top surface 222 of each of the tiers 220 comes in contact with the melted chocolate that flows off the top 212 of the housing so that the melted chocolate flows over each of the tiers 220 and returns to the basin 250 so that it may again be heated and lifted through the tubular housing 230 by the auger 240. In this way, the chocolate continues to circulate through the chocolate fountain 200 and creates levels of chocolate flowing like waterfalls. In this embodiment, in which the fountain 200 is configured to flow with three fluids, each tier 220 has three dividers 224 substantially impermeable to fluid and positioned so that the three fluids do not mix as they are flowing over the tiers.

The tiers 220 and dividers 224 may be formed of plastic using a molding process, such as injection molding. In one embodiment, the tiers 220 and dividers 224 are formed by metal casting or metal drawing, for example, or any other method known in the art. Accordingly, the tiers 220 and dividers 224 do not require welding and, thus, do not have any welding artifacts, such as burrs or pits, which may retain melted chocolate and increase the complexity of cleaning the tiers 220. In a preferred embodiment, the tiers 220 and dividers 224 are formed of injection molded plastic along with the tubular housing 230 so that the tubular housing, dividers and all three tiers are integral and comprise one piece of injection molded plastic. This reduces the number of parts and complexity of the fountain 200 and also makes the fountain easier to clean. Most preferably, the plastic is clear as clear plastic allows the user to easily determine whether the components are clean. While specific methods of manufacturing the tiers 220 and dividers 224 are discussed above, it is expressly contemplated that the tiers and dividers may be fabricated in any other way know in the art.

The basin 250 has a bottom surface 252 dividers 256 and sides 254, which are configured to hold fluidic materials. The dividers 256 are substantially impermeable to fluid, divide the basin 250 into three sections, and are positioned so that the fluids flowing down from the tiers 224 into the basin 250 do not mix within the basin. In one embodiment, the basin 250 is shaped so that the fluidic materials flow towards the center of the basin and are available to circulate up the tubular housing 230 on the augers 240. In particular, the angle between the bottom surface 252 and the sides 254 is sufficiently large so that the melted chocolate flows towards the bottom surface and the housing 230. Accordingly, because of the shape of the basin 250, pooling of melted chocolate on tie bottom surface 252 is reduced and substantially all of the melted chocolate circulates through the fountain 200 at a uniform rate. Because substantially all of the chocolate circulates through the fountain 200 at a uniform rate, the chocolate is more uniformly heated as it flows across the bottom surface 252 of the basin 250. In one embodiment, the angle between the bottom surface 252 and the sides 254 is greater than or equal to about 16 degrees. The angle between the bottom surface 252 and the sides 254 may further be increased to 20, 25, 30, or 25 degrees, for example, to maintain the chocolate on the bottom surface 252 of the basin 250.

The basin 250 may be comprised of any suitable material known in the art, such as metal. In one embodiment, the basin 250 comprises a material with a high thermal conductivity, such as aluminum, for example, thereby reducing the power requirements of the heating element. Additionally, basin 250 may be coated with one or more non-stick materials, such as Teflon. More preferably, however, the basin 250 is comprised of stainless steel. Aluminum and Teflon are scratched easily by cleaning utensils and aluminum tends to corrode. The basin 250 is preferably removeably attached to the base 280 for easier cleaning.

In one embodiment, food items, such as fruit, are dipped into the chocolate flowing downward from the mounted tiers 220 of the fountain 200. When the food items are removed from the flowing chocolate, and before the chocolate hardens on the food items, drops of chocolate may drip from the food item. If chocolate drips outside of the fountain 200, cleaning the outside surface of the fountain and/or the surface on which the fountain 200 sets may be required. Additionally, chocolate dripped outside of the fountain 200 is, in most circumstances, contaminated and unusable by the chocolate fountain 200. Thus, dripping chocolate is preferably caught by the basin 250 so that it may be recirculated through the chocolate fountain 200. In an advantageous embodiment, the diameter of the basin 250 is sufficiently large, and has a tapered lip 262 to capture a significant portion of the dripping chocolate. In one embodiment, the diameter of the basin 250 is grater than or equal to about 300 mm. In another embodiment, the diameter of the basin 250 is grater than or equal to about 375 mm. The diameter of the basin 250 may further be increased to any diameter, such as 500, 600, or 1000 mm, for example.

In an alternative embodiment, instead of a single basin 250 with dividers 224, multiple basins are positioned under the tiers 220 so that each of the fluids flowing from the tiers flows into, and each auger 240 transports fluids from, a distinct basin.

In a preferred embodiment, the base has three feet, one of which is adjustable in order to level the fountain. The base 280 preferably includes a bottom cover. In one embodiment, the bottom cover includes an access panel that may be opened to access the inside of the base 280. In this way, the components within the base 280 may be easily accessed and repaired. In another embodiment, other portions of the fountain 200 include access panels that allow the user or technician to easily access and/or repair the components within the base 280. The base 280 can be comprised of any suitable material known in the art.

In a preferred embodiment the motor 285 is mounted in the base 280 so that the auger 240 is directly driven by the motor and the auger does not require additional gears or belts, reducing the number of parts required for the fountain 200. The motor 285 may be any type suitable to provide rotary force. Preferably, a DC motor is used to drive the auger as DC motors are quiet and generate a lot of torque. Preferably the motor is capable of generating a torque of at least 0.3 Nm (Newton-meters), and a flow of at least 74 ml/seconds (millileters/second) per auger.

A bottom end of the shaft 244 of each auger 240 includes a cross-rod configured to connect each shaft 244 with the motor 285 so that the motor 285 rotates each auger. As the motor 285 provides a rotational force causing each auger 240 to rotate, melted chocolate, for example, in the basin 250 is moved upwardly along the length of the housing 230, traveling upon the top surface of each spiral flight 242. A blender-type seal is desirable between the auger and the motor to minimize leaking.

In one embodiment, the diameter of the auger 240, measured from the outer end of the spiral flight 242, is slightly less than the inner diameter of the housing 230. Thus, the auger 240 fits snuggly within the housing 230. The incline angle of the spiral flight 242 of the augers 240 is selected so that the chocolate travels upwardly as the augers 240 rotate and should not impede the flow or volume of fluid pushed by the auger. The incline angle of the spiral flights 242, preferably is about 25 degrees.

In one embodiment, the augers 240 are plastic and are fabricated using a molding process, such as an injection molding process. In one exemplary embodiment, the augers 240 are insert molded. In other embodiments, the augers 240 comprise other materials that are easy to clean and/or reduce the occurrence of contaminants that are mixed into the fluidic material due to friction between the auger 240 and the housing 230, such as metal, rubber, ceramic or any other suitable material known in the art or suitable combinations thereof. The auger 240 can be manufactured by any suitable means known in the art.

The tubular housing 230 preferably comprises a cylindrical section for each auger 240. Therefore, in the illustrated embodiment, the housing has three sections. Each section of the housing 230 is positioned in a different section of the basin 250. Thus the dividers 224 of the tiers 220 and the dividers 256 basin 250 and the sections of the housing 230 are all configured so that the multiple fluids flowing through the fountain 200 do not mix in the fountain. Alternatively, a separate housing 230 may house each auger 240.

Although the present invention has been described in considerable detail with reference to certain preferred versions thereof, other versions are possible. For example, the augers can be comprised of glass. Therefore, the spirit and scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A fountain comprising:
a basin configured to contain fluidic material;
a housing substantially perpendicular to the basin and configured to contain the fluidic material; and
a plurality of augers configured to move the fluidic material within the basin upwardly within the housing, wherein substantially all of the fluidic material returns to the basin, via a path outside of the housing, after the augers move the fluidic material to a top of the housing.

2. The fountain of claim 1 wherein the basin is configured to contain multiple fluidic materials so that there is substantially no mixing of the multiple fluidic materials in the basin.

3. The fountain of claim 2 wherein the basin has a divider substantially impermeable to fluid.

4. The fountain of claim 2 wherein each auger is configured to move a single fluidic material within the basin upwardly within the housing, and wherein the housing is configured so that there is substantially no mixing of the multiple fluidic materials in the housing.

5. The fountain of claim 2 having a tier, the tier being configured so that the multiple fluidic materials flow over the tier when flowing from the housing to the basin and so that the multiple fluidic materials substantially do not mix when flowing over the tier.

6. The fountain of claim 5 wherein the tier has a divider substantially impermeable to fluid.

7. The fountain of claim 1 comprising a plurality of basins.

8. The fountain of claim 1 wherein the basin further comprises a lip.

9. A fountain comprising:
a basin configured to contain fluidic material;
a plurality of housings substantially perpendicular to the basin and configured to contain the fluidic material; and
a plurality of augers configured to move the fluidic material within the basin upwardly within the plurality of housings, wherein substantially all of the fluidic material returns to the basin, via a path outside of the plurality of housings, after the augers move the fluidic material to a top of the plurality of housings.

10. The fountain of claim 9 comprising a plurality of basins.

11. A fountain comprising:
at least one basin configured to contain multiple fluidic materials so that there is substantially no mixing of the multiple fluidic materials in the at lease one basin;
at lease one housing substantially perpendicular to the at least one basin and configured to contain the multiple fluidic materials; and
a moving means configured to move the multiple fluidic materials within the at least one basin upwardly within the at least one housing, wherein substantially all of the multiple fluidic materials return to the at least one basin, via a path outside of the at least one housing after the moving means moves the multiple fluidic materials to a top of the at least one housing.

12. The fountain of claim 11 wherein the at least one housing is configured so that there is substantially no mixing of the multiple fluidic materials in the at least one housing.
